(19) United States
(12) Patent Application Publication
(10) Pub. No.: US 2016/0191764 A1
(43) Pub. Date: Jun. 30, 2016

(54) OPTICAL IMAGING LENS AND ELECTRONIC DEVICE COMPRISING THE SAME

(71) Applicants: Sheng-Wei Hsu, Taichung City (TW); Tzu-Chien Tang, Taichung City (TW)

(72) Inventors: Sheng-Wei Hsu, Taichung City (TW); Tzu-Chien Tang, Taichung City (TW)

(21) Appl. No.: 14/622,940

(22) Filed: Feb. 16, 2015

(30) Foreign Application Priority Data
Dec. 19, 2014 (TW) 103144556

(51) Int. Cl. H04N 5/225; G02B 9/34

(52) U.S. Cl. CPC H04N 5/2254; G02B 9/34; H04N 5/2252

(57) ABSTRACT

An optical imaging lens includes: an aperture stop, a first, second, third and fourth lens element arranged in order from an object side to an image side along an optical axis of the imaging lens. The image-side surface of the first lens element has a convex part in a vicinity of its periphery, the object-side surface of the second lens element has a concave portion in a vicinity of the optical axis, the object-side of the third lens element has a concave portion in a vicinity of the optical axis, and a convex part in a vicinity of its periphery; the object-side surface of the fourth lens element has a convex portion in a vicinity of the optical axis. The imaging lens satisfies T3/AAG≧1.4, (G12+G34)/T2≦1.4 and |V1−V4|≦20.

### CROSS REFERENCE TO RELATED APPLICATION

This application claims priority from Taiwan Patent Application No. 103144556, filed on Dec. 19, 2014, the contents of which are hereby incorporated by reference in their entirety for all purposes.

### BACKGROUND OF THE INVENTION

1. Field of the Invention

The present invention generally relates to an optical imaging lens set and an electronic device which includes such optical imaging lens set. Specifically speaking, the present invention is directed to an optical imaging lens set of four lens elements and an electronic device which includes such optical imaging lens set of four lens elements.

2. Description of the Prior Art

In recent years, the popularity of mobile phones and digital cameras makes photography modules (including optical imaging lens set, holder and sensor, etc) well developed. Mobile phones and digital cameras become lighter and thinner, so that the miniaturization demands of photography modules get higher and higher. As the charge coupled device (CCD) or complementary metal-oxide semiconductor (CMOS) technologies advance, the size of the photography modules can be shrunk too, but these photography modules still need to maintain good imaging quality.

Both Taiwan patents no. I422898 and I461732 disclose an optical imaging lens set of four lens elements respectively, and both of the total lengths (the distance between the first object size surface of the first lens element to an image plane) of the optical imaging lens sets are too large to satisfy the specification requirements of consumer electronics products.

### SUMMARY OF THE INVENTION

In light of the above, the present invention proposes an optical imaging lens set that is lightweight, has a low production cost, has an enlarged half field of view, has a high resolution and has high image quality. The optical imaging lens set of four lens elements of the present invention has an aperture stop, a first lens element, a second lens element, a third lens element and a fourth lens element sequentially from an object side to an image side along an optical axis.

The present invention provides an optical imaging lens including: an aperture stop, a first, second, third and fourth lens element arranged in order from an object side to an image side along an optical axis of said imaging lens, each of said first lens element, said second lens element, said third lens element, and said fourth lens element have an object-side surface facing toward the object side and an image-side surface facing toward the image side. Said image-side surface of said first lens element has a convex part in a vicinity of its periphery, said object-side surface of said second lens element has a concave portion in a vicinity of the optical axis, said object-side of said third lens element has a concave portion in a vicinity of the optical axis, and a convex part in a vicinity of its periphery; said object-side surface of said fourth lens element has a convex portion in a vicinity of the optical axis, wherein the optical imaging lens set does not include any lens element with refractive power other than said first, second, third and fourth lens elements.

In the optical imaging lens set of four lens elements of the present invention, an air gap G12 along the optical axis is disposed between the first lens element and the second lens element, an air gap G23 along the optical axis is disposed between the second lens element and the third lens element, an air gap G34 along the optical axis is disposed between the third lens element and the fourth lens element, and the sum of total three air gaps between adjacent lens elements from the first lens element to the fourth lens element along the optical axis is AAG, AAG=G12+G23+G34.

In the optical imaging lens set of four lens elements of the present invention, the first lens element has a first lens element thickness T1 along the optical axis, the second lens element has a second lens element thickness T2 along the optical axis, the third lens element has a third lens element thickness T3 along the optical axis, the fourth lens element has a fourth lens element thickness T4 along the optical axis, and the total thickness of all the lens elements in the optical imaging lens set along the optical axis is ALT, ALT=T1+T2+T3+T4.

In addition, the distance between the first object-side surface of the first lens element to the image plane is TTL. The distance between the image-side surface of the fourth lens element to an image plane along the optical axis is BFL (back focal length); the effective focal length of the optical imaging lens set is EFL.

Furthermore, the focal length of the first lens element 10 is f1; the focal length of the second lens element 20 is f2; the focal length of the third lens element 30 is f3; the focal length of the fourth lens element 40 is f4; the Abbe number of the first lens element 10 is V1; the Abbe number of the second lens element 20 is V2; the Abbe number of the third lens element 30 is V3; and the Abbe number of the fourth lens element 40 is V4.

In the optical imaging lens set of four lens elements of the present invention, the relationship T3/AAG≧1.4 is satisfied.

In the optical imaging lens set of four lens elements of the present invention, the relationship (G12+G34)/T2≦1.4 is satisfied.

In the optical imaging lens set of four lens elements of the present invention, the relationship |V1−V4|≦20 is satisfied.

In the optical imaging lens set of four lens elements of the present invention, the relationship (T1+T2)/AAG≦3.5 is satisfied.

In the optical imaging lens set of four lens elements of the present invention, the relationship ALT/T2≧5.8 is satisfied.

In the optical imaging lens set of four lens elements of the present invention, the relationship T2/T4≦0.9 is satisfied.

In the optical imaging lens set of four lens elements of the present invention, the relationship EFL/T1≧3.4 is satisfied.

In the optical imaging lens set of four lens elements of the present invention, the relationship ALT/AAG≦6.5 is satisfied.

In the optical imaging lens set of four lens elements of the present invention, the relationship TTL/(G34+T4)≦8.5 is satisfied.

In the optical imaging lens set of four lens elements of the present invention, the relationship EFL/T4≦6.8 is satisfied.

In the optical imaging lens set of four lens elements of the present invention, the relationship (T1+T3)/(G12+G23)≦5.0 is satisfied.

In the optical imaging lens set of four lens elements of the present invention, the relationship (AAG+ALT)/(G12+G34)≦11 is satisfied.

In the optical imaging lens set of four lens elements of the present invention, the relationship TTL/AAG≦11 is satisfied.

In the optical imaging lens set of four lens elements of the present invention, the relationship EFL+BFL≦3.0 is satisfied.

In the optical imaging lens set of four lens elements of the present invention, the relationship EFL/(G12+G23)≦7.5 is satisfied.

In the optical imaging lens set of four lens elements of the present invention, the relationship T1/T2≧1.7 is satisfied.

The present invention also proposes an electronic device which includes the optical imaging lens set as described above. The electronic device includes a case and an image module disposed in the case. The image module includes an optical imaging lens set as described above, a barrel for the installation of the optical imaging lens set, a module housing unit for the installation of the barrel, a substrate for the installation of the module housing unit, and an image sensor disposed on the substrate and at an image side of the optical imaging lens set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-5 illustrates the methods for determining the surface shapes and for determining one region being a region in a vicinity of the optical axis or the region in a vicinity of its circular periphery of one lens element.

FIG. 6 illustrates a first example of the optical imaging lens set of the present invention.

FIG. 7A illustrates the longitudinal spherical aberration on the image plane of the first example.

FIG. 7B illustrates the astigmatic aberration on the sagittal direction of the first example.

FIG. 7C illustrates the astigmatic aberration on the tangential direction of the first example.

FIG. 7D illustrates the distortion aberration of the first example.

FIG. 8 illustrates a second example of the optical imaging lens set of four lens elements of the present invention.

FIG. 9A illustrates the longitudinal spherical aberration on the image plane of the second example.

FIG. 9B illustrates the astigmatic aberration on the sagittal direction of the second example.

FIG. 9C illustrates the astigmatic aberration on the tangential direction of the second example.

FIG. 9D illustrates the distortion aberration of the second example.

FIG. 10 illustrates a third example of the optical imaging lens set of four lens elements of the present invention.

FIG. 11A illustrates the longitudinal spherical aberration on the image plane of the third example.

FIG. 11B illustrates the astigmatic aberration on the sagittal direction of the third example.

FIG. 11C illustrates the astigmatic aberration on the tangential direction of the third example.

FIG. 11D illustrates the distortion aberration of the third example.

FIG. 12 illustrates a fourth example of the optical imaging lens set of four lens elements of the present invention.

FIG. 13A illustrates the longitudinal spherical aberration on the image plane of the fourth example.

FIG. 13B illustrates the astigmatic aberration on the sagittal direction of the fourth example.

FIG. 13C illustrates the astigmatic aberration on the tangential direction of the fourth example.

FIG. 13D illustrates the distortion aberration of the fourth example.

FIG. 14 illustrates a fifth example of the optical imaging lens set of four lens elements of the present invention.

FIG. 15A illustrates the longitudinal spherical aberration on the image plane of the fifth example.

FIG. 15B illustrates the astigmatic aberration on the sagittal direction of the fifth example.

FIG. 15C illustrates the astigmatic aberration on the tangential direction of the fifth example.

FIG. 15D illustrates the distortion aberration of the fifth example.

FIG. 16 illustrates a sixth example of the optical imaging lens set of four lens elements of the present invention.

FIG. 17A illustrates the longitudinal spherical aberration on the image plane of the sixth example.

FIG. 17B illustrates the astigmatic aberration on the sagittal direction of the sixth example.

FIG. 17C illustrates the astigmatic aberration on the tangential direction of the sixth example.

FIG. 17D illustrates the distortion aberration of the sixth example.

FIG. 18 illustrates a seventh example of the optical imaging lens set of four lens elements of the present invention.

FIG. 19A illustrates the longitudinal spherical aberration on the image plane of the seventh example.

FIG. 19B illustrates the astigmatic aberration on the sagittal direction of the seventh example.

FIG. 19C illustrates the astigmatic aberration on the tangential direction of the seventh example.

FIG. 19D illustrates the distortion aberration of the seventh example.

FIG. 20 illustrates a first preferred example of the portable electronic device with an optical imaging lens set of the present invention.

FIG. 21 illustrates a second preferred example of the portable electronic device with an optical imaging lens set of the present invention.

FIG. 22 shows the optical data of the first example of the optical imaging lens set.

FIG. 23 shows the aspheric surface data of the first example.

FIG. 24 shows the optical data of the second example of the optical imaging lens set.

FIG. 25 shows the aspheric surface data of the second example.

FIG. 26 shows the optical data of the third example of the optical imaging lens set.

FIG. 27 shows the aspheric surface data of the third example.

FIG. 28 shows the optical data of the fourth example of the optical imaging lens set.

FIG. 29 shows the aspheric surface data of the fourth example.

FIG. 30 shows the optical data of the fifth example of the optical imaging lens set.

FIG. 31 shows the aspheric surface data of the fifth example.

FIG. 32 shows the optical data of the sixth example of the optical imaging lens set.

FIG. 33 shows the aspheric surface data of the sixth example.

FIG. 34 shows the optical data of the seventh example of the optical imaging lens set.

FIG. 35 shows the aspheric surface data of the seventh example.

FIG. 36 shows some important ratios in the examples.

### DETAILED DESCRIPTION

In the present specification, the description “a lens element having positive refracting power (or negative refracting power)” means that the paraxial refracting power of the lens element in Gaussian optics is positive (or negative). The description “An object-side (or image-side) surface of a lens element” only includes a specific region of that surface of the lens element where imaging rays are capable of passing through that region, namely the clear aperture of the surface. The aforementioned imaging rays can be classified into two types, chief ray Lc and marginal ray Lm. Taking a lens element depicted in FIG. 1 as an example, the lens element is rotationally symmetric, where the optical axis I is the axis of symmetry. The region A of the lens element is defined as “a portion in a vicinity of the optical axis”, and the region C of the lens element is defined as “a portion in a vicinity of a periphery of the lens element”. Besides, the lens element may also have an extending portion E extended radially and outwardly from the region C, namely the portion outside of the clear aperture of the lens element. The extending portion E is usually used for physically assembling the lens element into an optical imaging lens system. Under normal circumstances, the imaging rays would not pass through the extending portion E because those imaging rays only pass through the clear aperture. The structures and shapes of the aforementioned extending portion E are only examples for technical explanation, the structures and shapes of lens elements should not be limited to these examples. Note that the extending portions of the lens element surfaces depicted in the following embodiments are partially omitted.

The following criteria are provided for determining the shapes and the portions of lens element surfaces set forth in the present specification. These criteria mainly determine the boundaries of portions under various circumstances including the portion in a vicinity of the optical axis, the portion in a vicinity of a periphery of a lens element surface, and other types of lens element surfaces such as those having multiple portions.

1. FIG. 1 is a radial cross-sectional view of a lens element. Before determining boundaries of those aforesaid portions, two referential points should be defined first, central point and transition point. The central point of a surface of a lens element is a point of intersection of that surface and the optical axis. The transition point is a point on a surface of a lens element, where the tangent line of that point is perpendicular to the optical axis. Additionally, if multiple transition points appear on one single surface, then these transition points are sequentially named along the radial direction of the surface with numbers starting from the first transition point. For instance, the first transition point (closest one to the optical axis), the second transition point, and the Nth transition point (farthest one to the optical axis within the scope of the clear aperture of the surface). The portion of a surface of the lens element between the central point and the first transition point is defined as the portion in a vicinity of the optical axis. The portion located radially outside of the Nth transition point (but still within the scope of the clear aperture) is defined as the portion in a vicinity of a periphery of the lens element. In some embodiments, there are other portions existing between the portion in a vicinity of the optical axis and the portion in a vicinity of a periphery of the lens element; the numbers of portions depend on the numbers of the transition point(s). In addition, the radius of the clear aperture (or a so-called effective radius) of a surface is defined as the radial distance from the optical axis I to a point of intersection of the marginal ray Lm and the surface of the lens element.

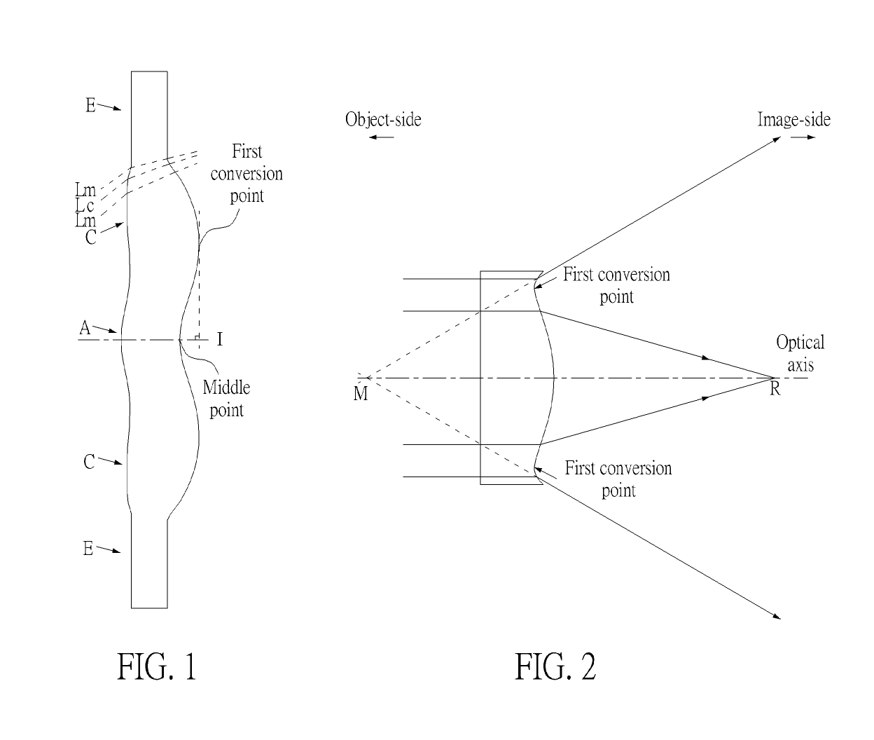

2. Referring to FIG. 2, determining the shape of a portion is convex or concave depends on whether a collimated ray passing through that portion converges or diverges. That is, while applying a collimated ray to a portion to be determined in terms of shape, the collimated ray passing through that portion will be bended and the ray itself or its extension line will eventually meet the optical axis. The shape of that portion can be determined by whether the ray or its extension line meets (intersects) the optical axis (focal point) at the object-side or image-side. For instance, if the ray itself intersects the optical axis at the image side of the lens element after passing through a portion, i.e. the focal point of this ray is at the image side (see point R in FIG. 2), the portion will be determined as having a convex shape. On the contrary, if the ray diverges after passing through a portion, the extension line of the ray intersects the optical axis at the object side of the lens element, i.e. the focal point of the ray is at the object side (see point M in FIG. 2), that portion will be determined as having a concave shape. Therefore, referring to FIG. 2, the portion between the central point and the first transition point has a convex shape, the portion located radially outside of the first transition point has a concave shape, and the first transition point is the point where the portion having a convex shape changes to the portion having a concave shape, namely the border of two adjacent portions. Alternatively, there is another common way for a person with ordinary skill in the art to tell whether a portion in a vicinity of the optical axis has a convex or concave shape by referring to the sign of an “R” value, which is the (paraxial) radius of curvature of a lens surface. The R value which is commonly used in conventional optical design software such as Zemax and CodeV. The R value usually appears in the lens data sheet in the software. For an object-side surface, positive R means that the object-side surface is convex, and negative R means that the object-side surface is concave. Conversely, for an image-side surface, positive R means that the image-side surface is concave, and negative R means that the image-side surface is convex. The result found by using this method should be consistent as by using the other way mentioned above, which determines surface shapes by referring to whether the focal point of a collimated ray is at the object side or the image side.

3. For none transition point cases, the portion in a vicinity of the optical axis is defined as the portion between 0˜50% of the effective radius (radius of the clear aperture) of the surface, whereas the portion in a vicinity of a periphery of the lens element is defined as the portion between 50˜100% of effective radius (radius of the clear aperture) of the surface.

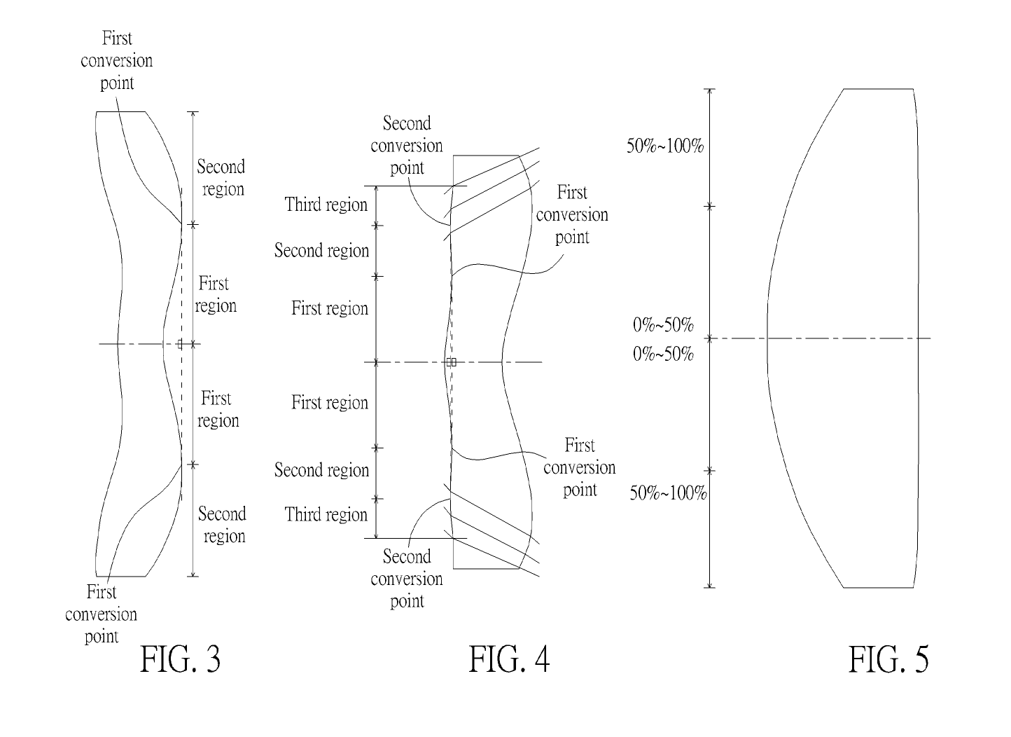

Referring to the first example depicted in FIG. 3, only one transition point, namely a first transition point, appears within the clear aperture of the image-side surface of the lens element. Portion I is a portion in a vicinity of the optical axis, and portion II is a portion in a vicinity of a periphery of the lens element. The portion in a vicinity of the optical axis is determined as having a concave surface due to the R value at the image-side surface of the lens element is positive. The shape of the portion in a vicinity of a periphery of the lens element is different from that of the radially inner adjacent portion, i.e. the shape of the portion in a vicinity of a periphery of the lens element is different from the shape of the portion in a vicinity of the optical axis; the portion in a vicinity of a periphery of the lens element has a convex shape.

Referring to the second example depicted in FIG. 4, a first transition point and a second transition point exist on the object-side surface (within the clear aperture) of a lens element. In which portion I is the portion in a vicinity of the optical axis, and portion III is the portion in a vicinity of a periphery of the lens element. The portion in a vicinity of the optical axis has a convex shape because the R value at the object-side surface of the lens element is positive. The portion in a vicinity of a periphery of the lens element (portion III) has a convex shape. What is more, there is another portion having a concave shape existing between the first and second transition point (portion II).

Referring to a third example depicted in FIG. 5, no transition point exists on the object-side surface of the lens element. In this case, the portion between 0˜50% of the effective radius (radius of the clear aperture) is determined as the portion in a vicinity of the optical axis, and the portion between 50˜100% of the effective radius is determined as the portion in a vicinity of a periphery of the lens element. The portion in a vicinity of the optical axis of the object-side surface of the lens element is determined as having a convex shape due to its positive R value, and the portion in a vicinity of a periphery of the lens element is determined as having a convex shape as well.

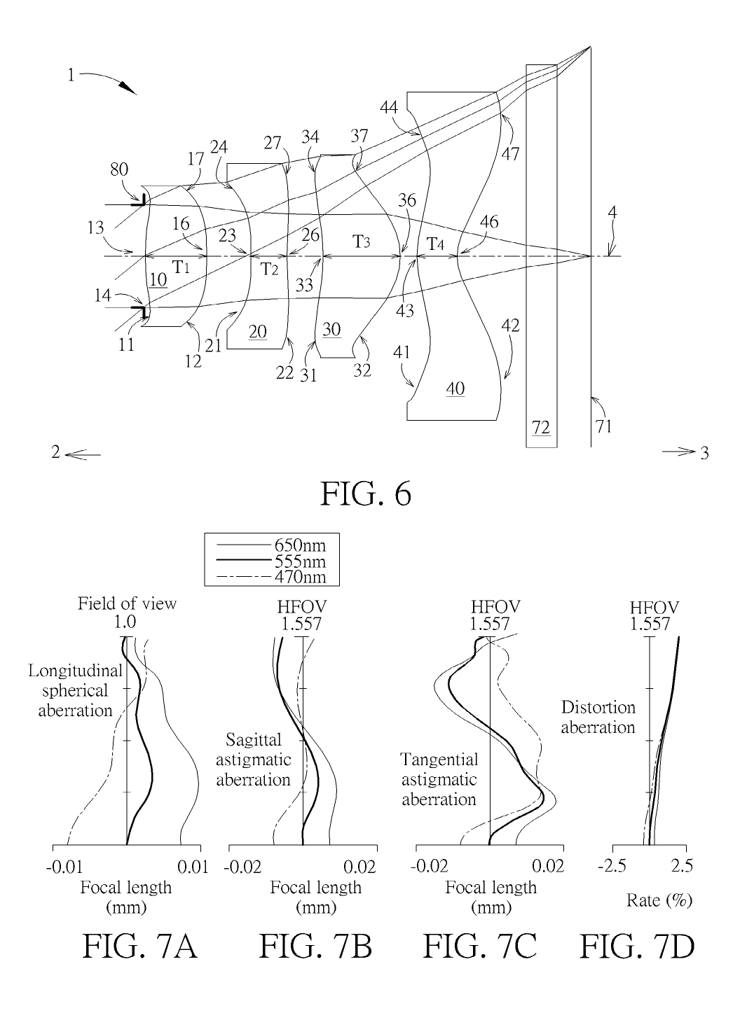

As shown in FIG. 6, the optical imaging lens set 1 of four lens elements of the present invention, sequentially located from an object side 2 (where an object is located) to an image side 3 along an optical axis 4, have an aperture stop 80, a first lens element 10, a second lens element 20, a third lens element 30, a fourth lens element 40, a filter 72 and an image plane 71. Generally speaking, the first lens element 10, the second lens element 20, the third lens element 30, and the fourth lens element 40 may be made of a transparent plastic material and each has an appropriate refractive power, but the present invention is not limited to this. There are exclusively four lens elements with refractive power in the optical imaging lens set 1 of the present invention. The optical axis 4 is the optical axis of the entire optical imaging lens set 1, and the optical axis of each of the lens elements coincides with the optical axis of the optical imaging lens set 1.

Furthermore, the optical imaging lens set 1 includes an aperture stop (ape. stop) 80 disposed in an appropriate position. In FIG. 6, the aperture stop 80 is disposed between the object side 2 and the first lens element 10. When light emitted or reflected by an object (not shown) which is located at the object side 2 enters the optical imaging lens set 1 of the present invention, it forms a clear and sharp image on the image plane 71 at the image side 3 after passing through the aperture stop 80, the first lens element 10, the second lens element 20, the third lens element 30, the fourth lens element 40 and the filter 72.

In the embodiments of the present invention, the optional filter 72 may be a filter of various suitable functions, for example, the filter 72 may be an infrared cut filter (IR cut filter), placed between the fourth lens element 40 and the image plane 71. The filter 72 is made of glass.

Each lens element in the optical imaging lens set 1 of the present invention has an object-side surface facing toward the object side 2 as well as an image-side surface facing toward the image side 3. For example, the first lens element 10 has a first object-side surface 11 and a first image-side surface 12; the second lens element 20 has a second object-side surface 21 and a second image-side surface 22; the third lens element 30 has a third object-side surface 31 and a third image-side surface 32; the fourth lens element 40 has a fourth object-side surface 41 and a fourth image-side surface 42. In addition, each object-side surface and image-side surface in the optical imaging lens set 1 of the present invention has a part (or portion) in a vicinity of its circular periphery (circular periphery part) away from the optical axis 4 as well as a part in a vicinity of the optical axis (optical axis part) close to the optical axis 4.

Each lens element in the optical imaging lens set 1 of the present invention further has a central thickness on the optical axis 4. For example, the first lens element 10 has a first lens element thickness T1, the second lens element 20 has a second lens element thickness T2, the third lens element 30 has a third lens element thickness T3, the fourth lens element 40 has a fourth lens element thickness T4. Therefore, the total thickness of all the lens elements in the optical imaging lens set 1 along the optical axis 4 is ALT, ALT=T1+T2+T3+T4.

In addition, between two adjacent lens elements in the optical imaging lens set 1 of the present invention there is an air gap along the optical axis 4. For example, an air gap G12 is disposed between the first lens element 10 and the second lens element 20, an air gap G23 is disposed between the second lens element 20 and the third lens element 30, and an air gap G34 is disposed between the third lens element 30 and the fourth lens element 40. Therefore, the sum of total three air gaps between adjacent lens elements from the first lens element 10 to the fourth lens element 40 along the optical axis 4 is AAG, AAG=G12+G23+G34.

In addition, the distance between the first object-side surface 11 of the first lens element 10 to the image plane 71, namely the total length of the optical imaging lens set along the optical axis 4 is TTL; the effective focal length of the optical imaging lens set is EFL; the distance between the fourth image-side surface 42 of the four lens element 40 to the image plane 71 along the optical axis 4 is BFL; the distance between the fourth image-side surface 42 of the four lens element 40 to the filter 72 along the optical axis 4 is G4F; the thickness of the filter 72 along the optical axis 4 is TF; the distance between the filter 72 to the image plane 71 along the optical axis 4 is GFP; Therefore, BFL=G4F+TF+GFP.

Furthermore, the focal length of the first lens element 10 is f1; the focal length of the second lens element 20 is f2; the focal length of the third lens element 30 is f3; the focal length of the fourth lens element 40 is f4; the refractive index of the first lens element 10 is n1; the refractive index of the second lens element 20 is n2; the refractive index of the third lens element 30 is n3; the refractive index of the fourth lens element 40 is n4; the Abbe number of the first lens element 10 is V1; the Abbe number of the second lens element 20 is V2; the Abbe number of the third lens element 30 is V3; and the Abbe number of the fourth lens element 40 is V4.

### FIRST EXAMPLE

Please refer to FIG. 6 which illustrates the first example of the optical imaging lens set 1 of the present invention. Please refer to FIG. 7A for the longitudinal spherical aberration on the image plane 71 of the first example; please refer to FIG. 7B for the astigmatic field aberration on the sagittal direction; please refer to FIG. 7C for the astigmatic field aberration on the tangential direction, and please refer to FIG. 7D for the distortion aberration. The Y axis of the spherical aberration in each example is “field of view” for 1.0. The Y axis of the astigmatic field and the distortion in each example stand for image height. The image height is 1.557 mm. The X axis of the spherical aberration and the astigmatic field in each example is the image range.

The optical imaging lens set 1 of the first example has four lens elements 10 to 40 made of a plastic material and having refractive power. The optical imaging lens set 1 also has an aperture stop 80, a filter 72, and an image plane 71. The aperture stop 80 is provided between the object side 2 and the first lens element 10. The filter 72 may be used for preventing specific wavelength light (such as the infrared light) reaching the image plane to adversely affect the imaging quality.

The first lens element 10 has positive refractive power. The first object-side surface 11 facing toward the object side 2 is a convex surface, having a convex part 13 in the vicinity of the optical axis and a convex part 14 in a vicinity of its circular periphery. The first image-side surface 12 facing toward the image side 3 is a convex surface, having a convex part 16 in the vicinity of the optical axis and a convex part 17 in a vicinity of its circular periphery. Besides, both the first object-side surface 11 and the first image-side 12 of the first lens element 10 are aspherical surfaces.

The second lens element 20 has negative refractive power. The second object-side surface 21 facing toward the object side 2 has a concave part 23 in the vicinity of the optical axis and a concave part 24 in a vicinity of its circular periphery. The second image-side surface 22 facing toward the image side 3 has a concave part 26 in the vicinity of the optical axis and a convex part 27 in a vicinity of its circular periphery. Both the second object-side surface 21 and the second image-side 22 of the second lens element 20 are aspherical surfaces.

The third lens element 30 has positive refractive power. The third object-side surface 31 facing toward the object side 2 has a concave part 33 in the vicinity of the optical axis and a convex part 34 in a vicinity of its circular periphery. The third image-side surface 32 facing toward the image side 3 has a convex part 36 in the vicinity of the optical axis and a concave part 37 in a vicinity of its circular periphery. Both the third object-side surface 31 and the third image-side 32 of the third lens element 30 are aspherical surfaces.

The fourth lens element 40 has negative refractive power. The fourth object-side surface 41 facing toward the object side 2 has a convex part 43 in the vicinity of the optical axis and a concave part 44 in a vicinity of its circular periphery. The fourth image-side surface 42 facing toward the image side 3 has a concave part 46 in the vicinity of the optical axis and a convex part 47 in a vicinity of its circular periphery. Both the fourth object-side surface 41 and the fourth image-side 42 of the fourth lens element 40 are aspherical surfaces. The filter 72 may be disposed between the fourth lens element 40 and the image plane 71.

In the optical imaging lens element 1 of the present invention, the object-side surfaces 11/21/31/41 and image-side surfaces 12/22/32/42 are all aspherical. These aspheric coefficients are defined according to the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i}$$

In which:

R represents the curvature radius of the lens element surface;

Z represents the depth of an aspherical surface (the perpendicular distance between the point of the aspherical surface at a distance Y from the optical axis and the tangent plane of the vertex on the optical axis of the aspherical surface);

Y represents a vertical distance from a point on the aspherical surface to the optical axis;

K is a conic constant; and

a2i is the aspheric coefficient of the 2i order.

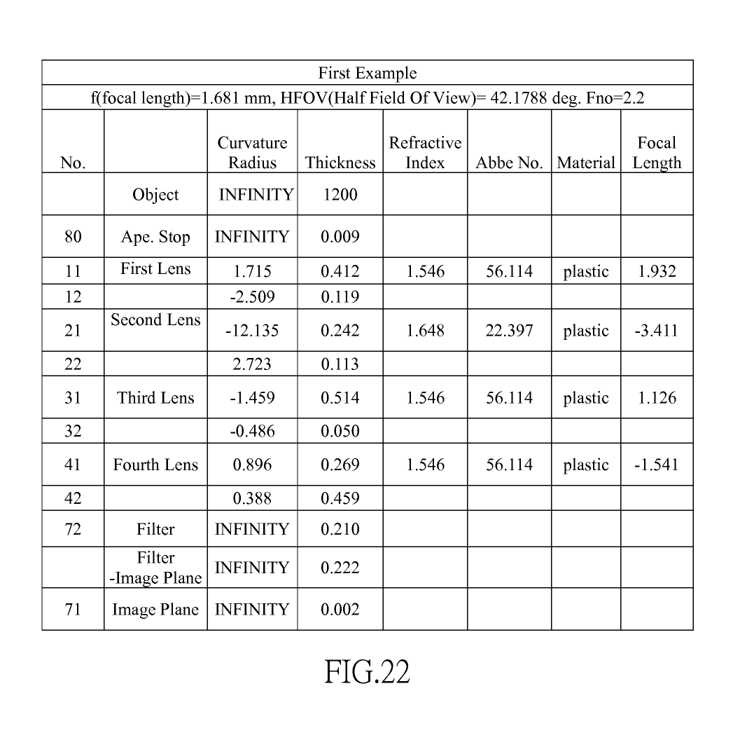

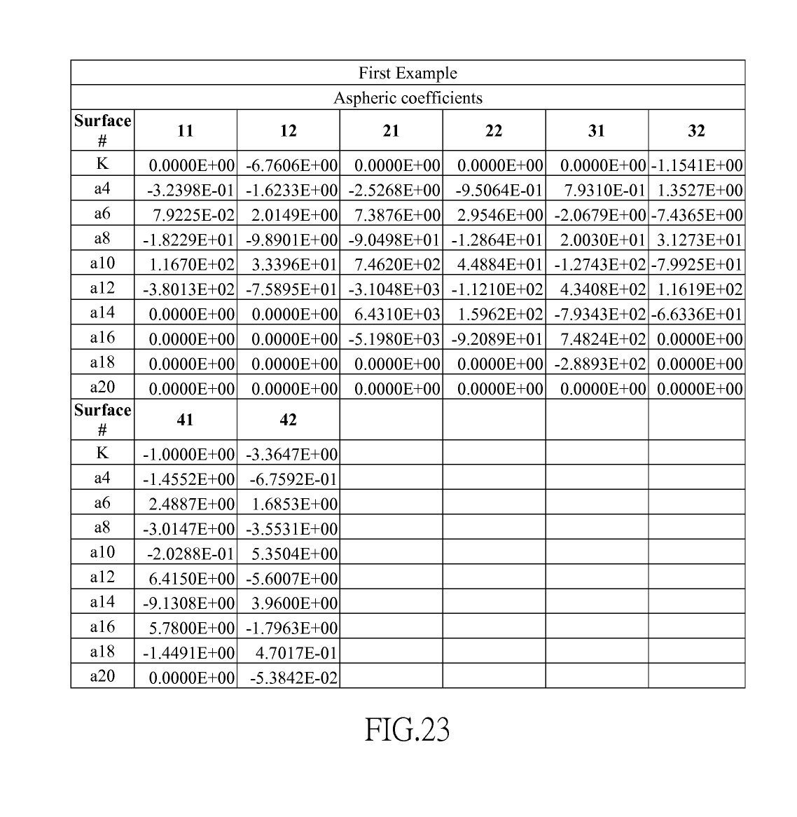

The optical data of the first example of the optical imaging lens set 1 are shown in FIG. 22 while the aspheric surface data are shown in FIG. 23. In the present examples of the optical imaging lens set, the f-number of the entire optical lens element system is Fno, HFOV stands for the half field of view which is half of the field of view of the entire optical lens element system, and the unit for the curvature radius, the thickness and the focal length is in millimeters (mm). The length of the optical imaging lens set (the distance from the first object-side surface 11 of the first lens element 10 to the image plane 71) is 2.612 mm. Image height is 1.557 mm, HFOV is 42.1788 degrees. Some important ratios of the first example are as follows:

T3/AAG=1.824

(G12+G34)/T2=0.697

|V1−V4|=0.000

(T1+T2)/AAG=2.319

T2/T4=0.899

ALT/AAG=5.097

EFL/T4=6.246

EFL+BFL=2.574

EFL/(G12+G23)=7.246

ALT/T2=5.941

EFL/T1=4.081

TTL/(G34+T4)=8.185

(T1+T3)/(G12+G23)=3.993

(AAG+ALT)/(G12+G34)=10.191

TTL/AAG=9.263

T1/T2=1.702

### SECOND EXAMPLE

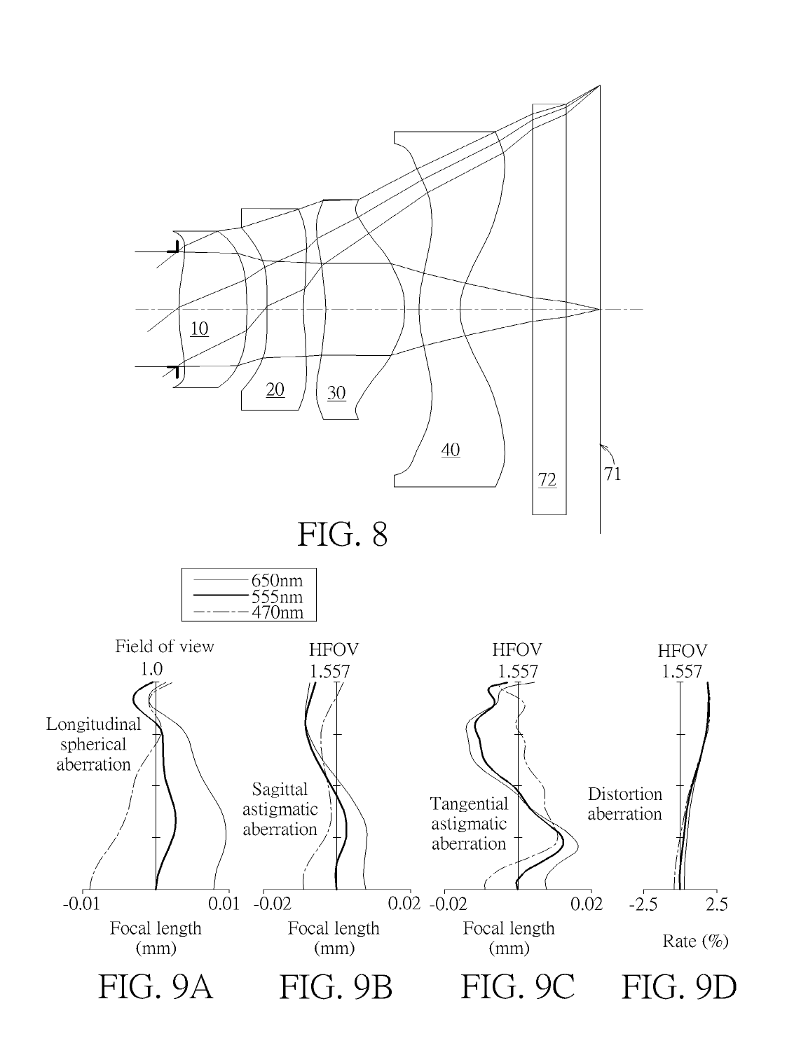

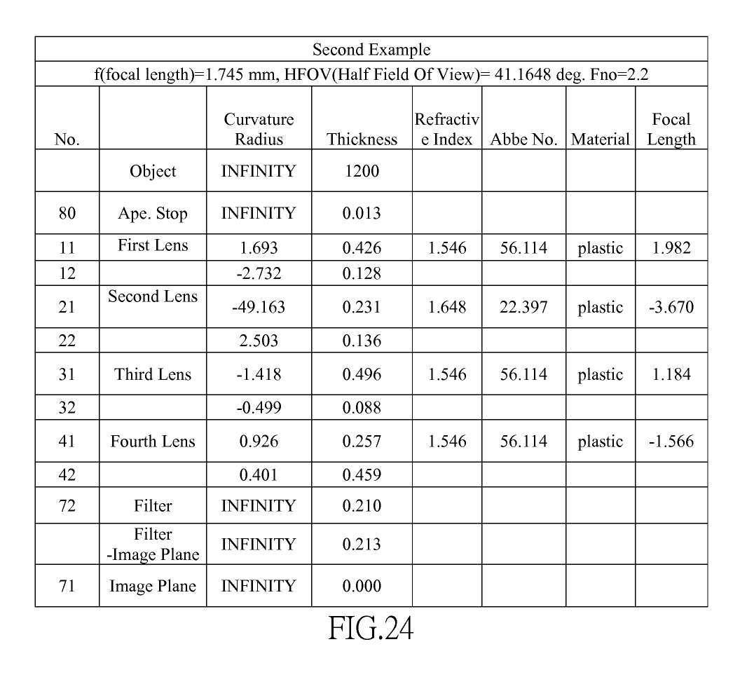

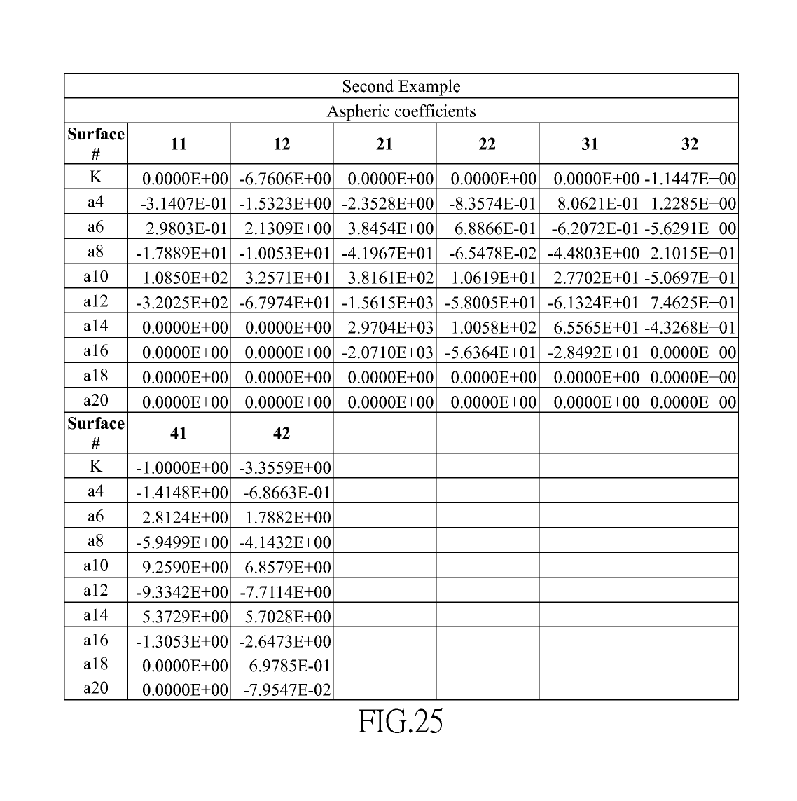

Please refer to FIG. 8 which illustrates the second example of the optical imaging lens set 1 of the present invention. It is noted that from the second example to the following examples, in order to simplify the figures, only the components different from what the first example has and the basic lens elements will be labeled in figures. Other components that are the same as what the first example has, such as the object-side surface, the image-side surface, the part in a vicinity of the optical axis and the part in a vicinity of its circular periphery will be omitted in the following example. Please refer to FIG. 9A for the longitudinal spherical aberration on the image plane 71 of the second example; please refer to FIG. 9B for the astigmatic aberration on the sagittal direction; please refer to FIG. 9C for the astigmatic aberration on the tangential direction, and please refer to FIG. 9D for the distortion aberration. The components in the second example are similar to those in the first example, but the optical data such as the curvature radius, the refractive power, the lens thickness, the lens focal length, the aspheric surface or the back focal length in this example are different from the optical data in the first example. The optical data of the second example of the optical imaging lens set are shown in FIG. 24 while the aspheric surface data are shown in FIG. 25. The length of the optical imaging lens set is 2.646 mm. Image height is 1.557 mm, HFOV is 41.1648 degrees. Some important ratios of the second example are as follows:

T3/AAG=1.407

(G12+G34)/T2=0.938

|V1−V4|=0.000

(T1+T2)/AAG=1.864

T2/T4=0.899

ALT/AAG=4.000

EFL/T4=6.788

EFL+BFL=2.627

EFL/(G12+G23)=6.602

ALT/T2=6.103

EFL/T1=4.093

TTL/(G34+T4)=7.659

(T1+T3)/(G12+G23)=3.490

(AAG+ALT)/(G12+G34)=8.133

TTL/AAG=7.503

T1/T2=1.844

### THIRD EXAMPLE

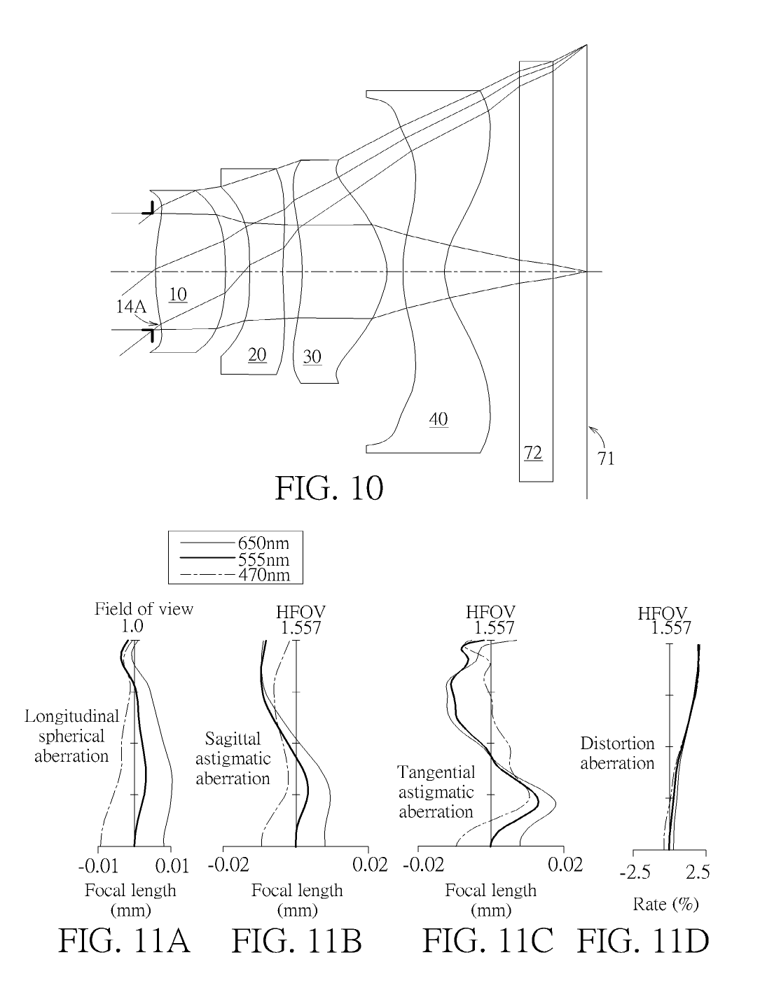

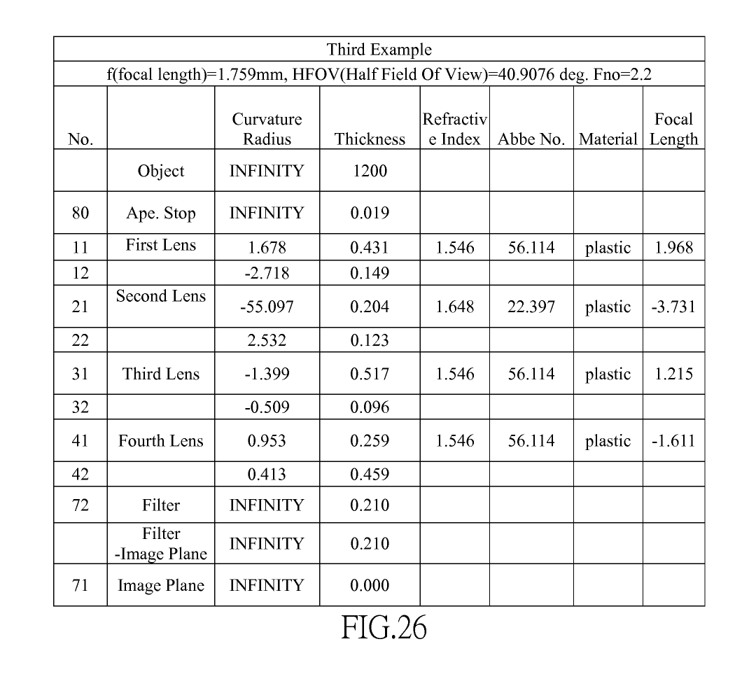

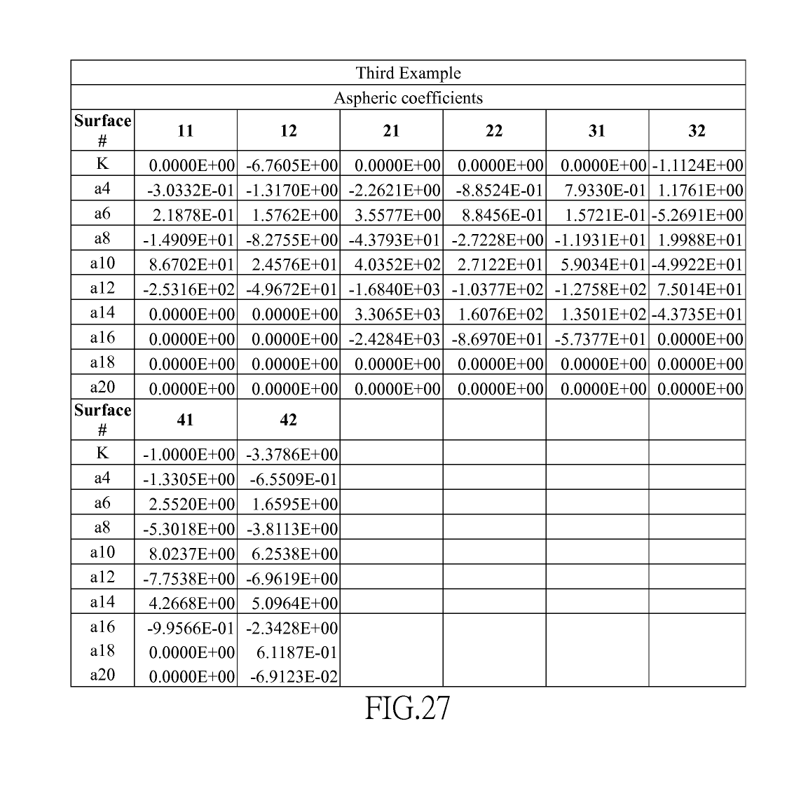

Please refer to FIG. 10 which illustrates the third example of the optical imaging lens set 1 of the present invention. Please refer to FIG. 11A for the longitudinal spherical aberration on the image plane 71 of the third example; please refer to FIG. 11B for the astigmatic aberration on the sagittal direction; please refer to FIG. 11C for the astigmatic aberration on the tangential direction, and please refer to FIG. 11D for the distortion aberration. The components in the third example are similar to those in the first example, but the optical data such as the curvature radius, the refractive power, the lens thickness, the lens focal length, the aspheric surface or the back focal length in this example are different from the optical data in the first example, and in this example, the first object-side surface 11 the first lens element 10 has a concave part 14A in a vicinity of its circular periphery. The optical data of the third example of the optical imaging lens set are shown in FIG. 26 while the aspheric surface data are shown in FIG. 27. The length of the optical imaging lens set is 2.657 mm. Image height is 1.557 mm, HFOV is 40.9076 degrees. Some important ratios of the third example are as follows:

T3/AAG=1.405

(G12+G34)/T2=1.200

|V1−V4|=0.000

(T1+T2)/AAG=1.725

T2/T4=0.788

ALT/AAG=3.834

EFL/T4=6.792

EFL+BFL=2.638

EFL/(G12+G23)=6.473

ALT/T2=6.914

EFL/T1=4.085

TTL/(G34+T4)=7.485

(T1+T3)/(G12+G23)=3.486

(AAG+ALT)/(G12+G34)=7.264

TTL/AAG=7.225

T1/T2=2.111

### FOURTH EXAMPLE

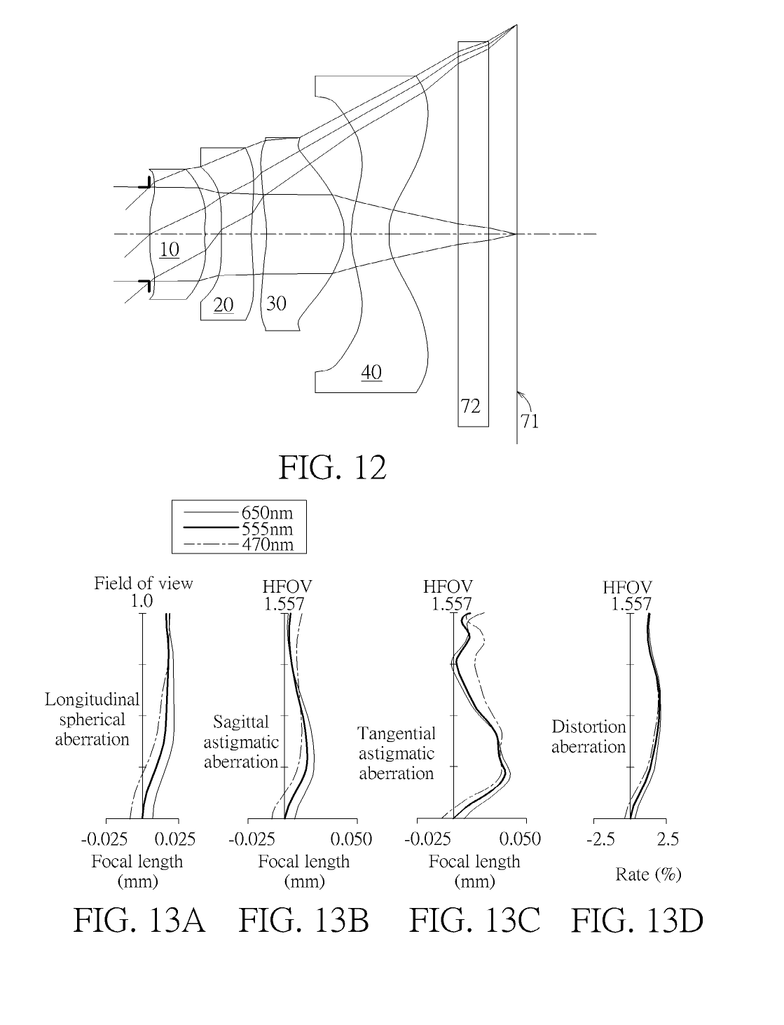

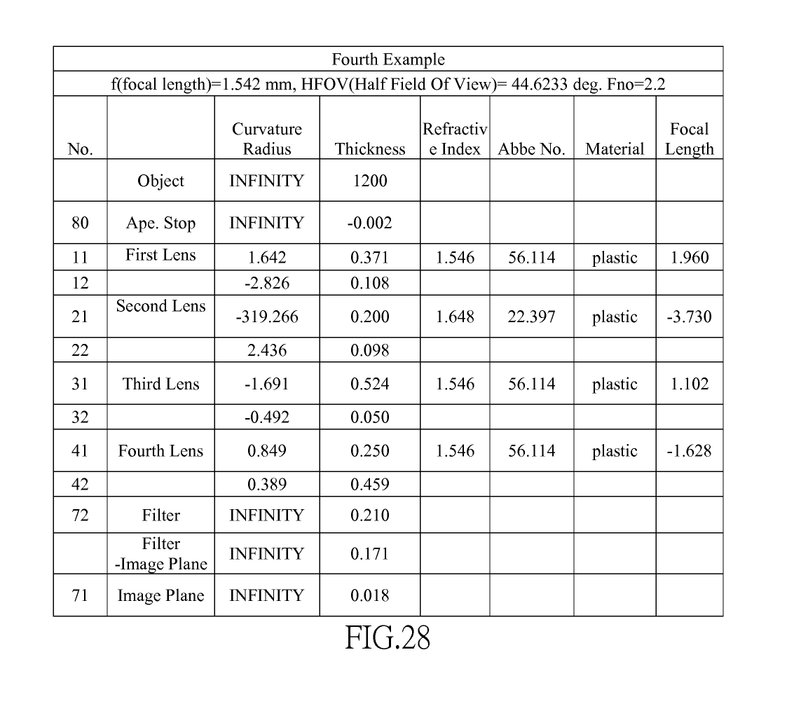

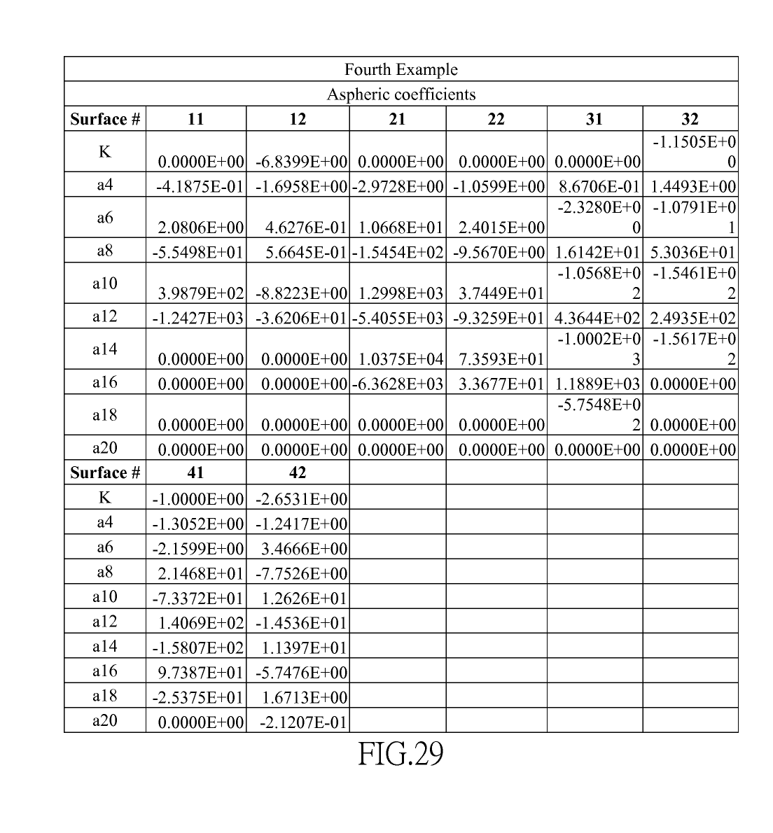

Please refer to FIG. 12 which illustrates the fourth example of the optical imaging lens set 1 of the present invention. Please refer to FIG. 13A for the longitudinal spherical aberration on the image plane 71 of the fourth example; please refer to FIG. 13B for the astigmatic aberration on the sagittal direction; please refer to FIG. 13C for the astigmatic aberration on the tangential direction, and please refer to FIG. 13D for the distortion aberration. The components in the fourth example are similar to those in the first example, but the optical data such as the curvature radius, the refractive power, the lens thickness, the lens focal length, the aspheric surface or the back focal length in this example are different from the optical data in the first example. The optical data of the fourth example of the optical imaging lens set are shown in FIG. 28 while the aspheric surface data are shown in FIG. 29. The length of the optical imaging lens set is 2.460 mm. Image height is 1.557 mm, HFOV is 44.6233 degrees. Some important ratios of the fourth example are as follows:

T3/AAG=2.048

(G12+G34)/T2=0.792

|V1−V4|=0.000

(T1+T2)/AAG=2.234

T2/T4=0.800

ALT/AAG=5.529

EFL/T4=6.168

EFL+BFL=2.400

EFL/(G12+G23)=7.491

ALT/T2=6.727

EFL/T1=4.151

TTL/(G34+T4)=8.198

(T1+T3)/(G12+G23)=4.350

(AAG+ALT)/(G12+G34)=10.114

TTL/AAG=9.614

T1/T2=1.857

### FIFTH EXAMPLE

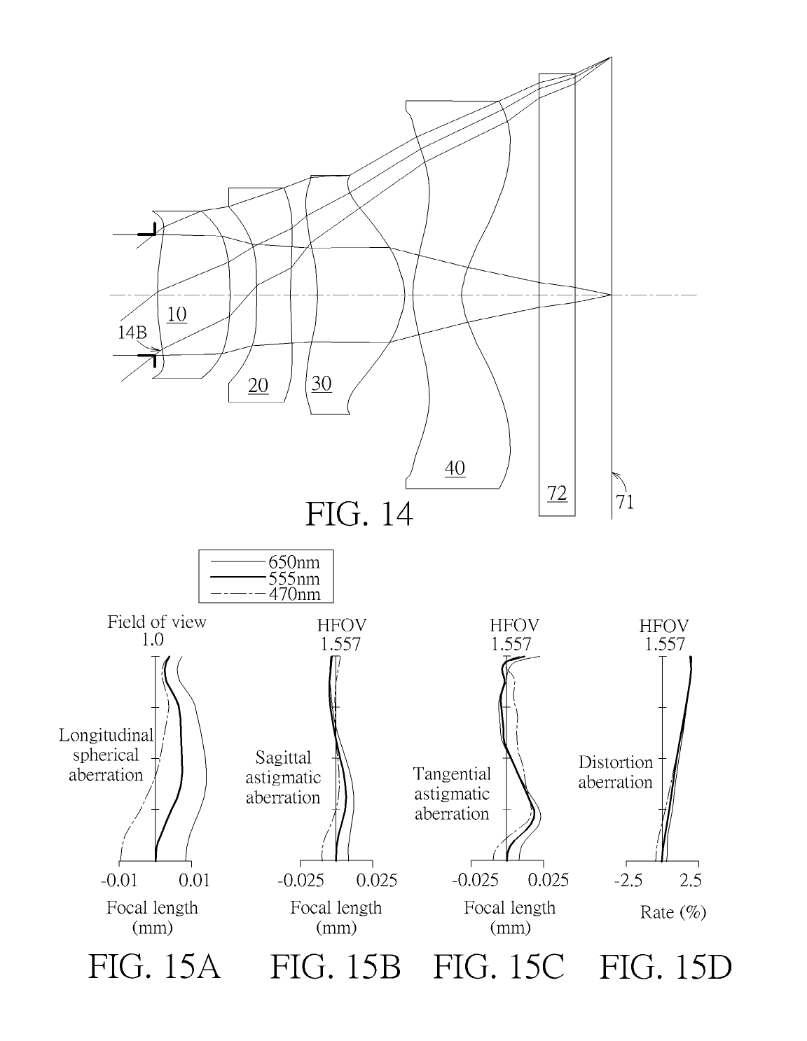

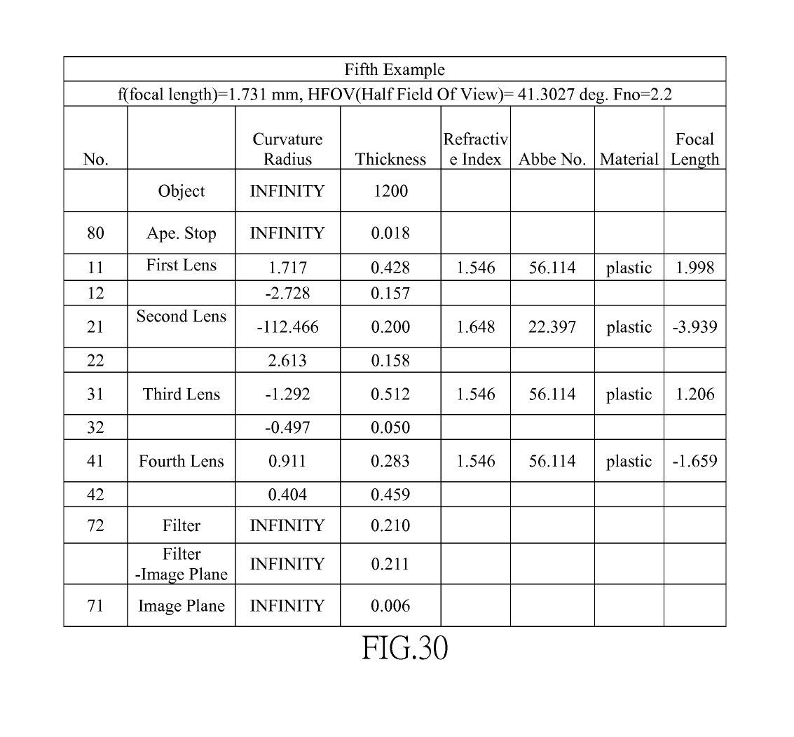

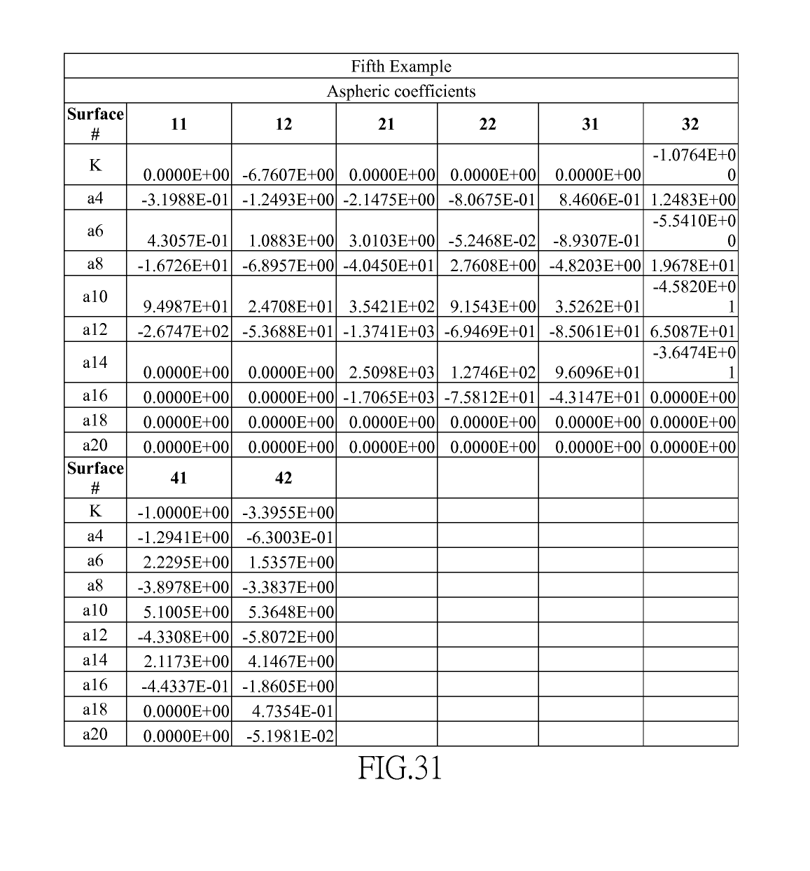

Please refer to FIG. 14 which illustrates the fifth example of the optical imaging lens set 1 of the present invention. Please refer to FIG. 15A for the longitudinal spherical aberration on the image plane 71 of the fifth example; please refer to FIG. 15B for the astigmatic aberration on the sagittal direction; please refer to FIG. 15C for the astigmatic aberration on the tangential direction, and please refer to FIG. 15D for the distortion aberration. The components in the fifth example are similar to those in the first example, but the optical data such as the curvature radius, the refractive power, the lens thickness, the lens focal length, the aspheric surface or the back focal length in this example are different from the optical data in the first example, and in this example, the first object-side surface 11 the first lens element 10 has a concave part 14B in a vicinity of its circular periphery. The optical data of the fifth example of the optical imaging lens set are shown in FIG. 30 while the aspheric surface data are shown in FIG. 31. The length of the optical imaging lens set is 2.675 mm. Image height is 1.557 mm, HFOV is 41.3027 degrees. Some important ratios of the fifth example are as follows:

T3/AAG=1.405

(G12+G34)/T2=1.034

|V1−V4|=0.000

(T1+T2)/AAG=1.723

T2/T4=0.706

ALT/AAG=3.904

EFL/T4=6.112

EFL+BFL=2.617

EFL/(G12+G23)=5.500

ALT/T2=7.119

EFL/T1=4.042

TTL/(G34+T4)=8.027

(T1+T3)/(G12+G23)=2.989

(AAG+ALT)/(G12+G34)=8.651

TTL/AAG=7.334

T1/T2=2.141

### SIXTH EXAMPLE

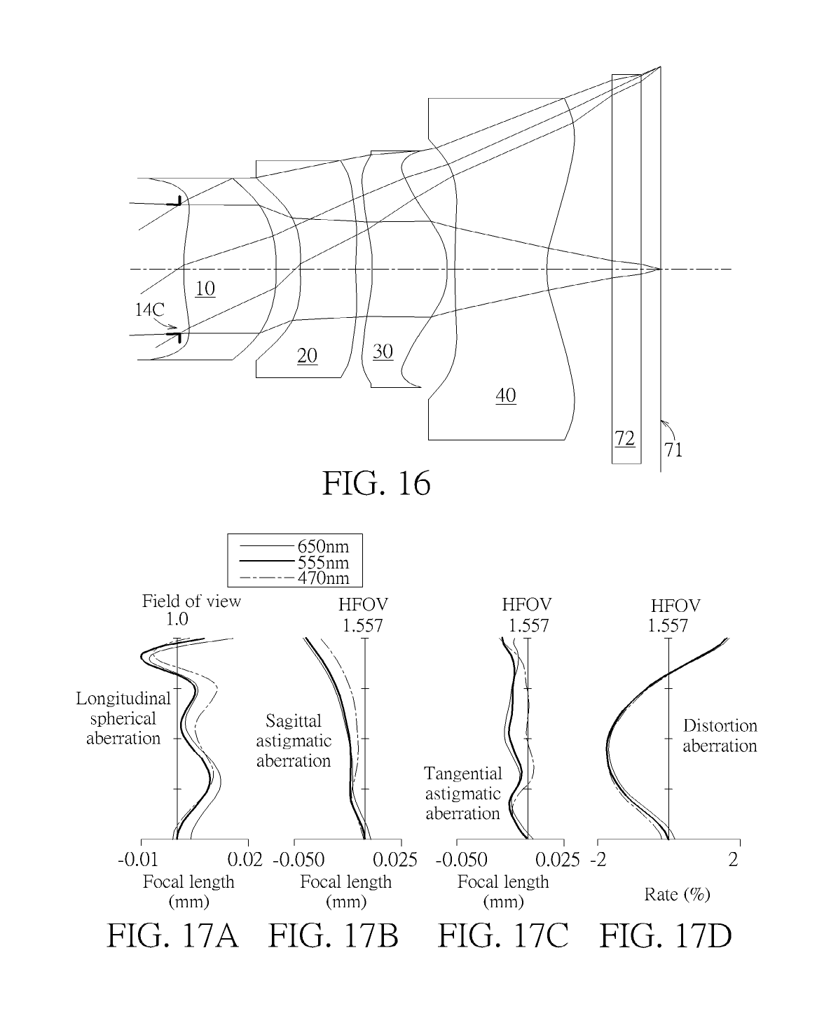

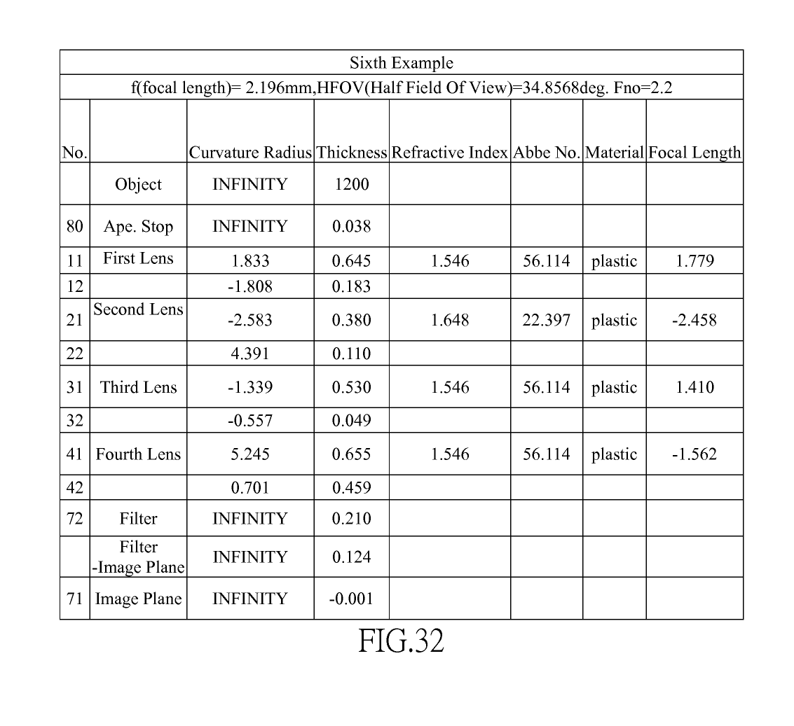

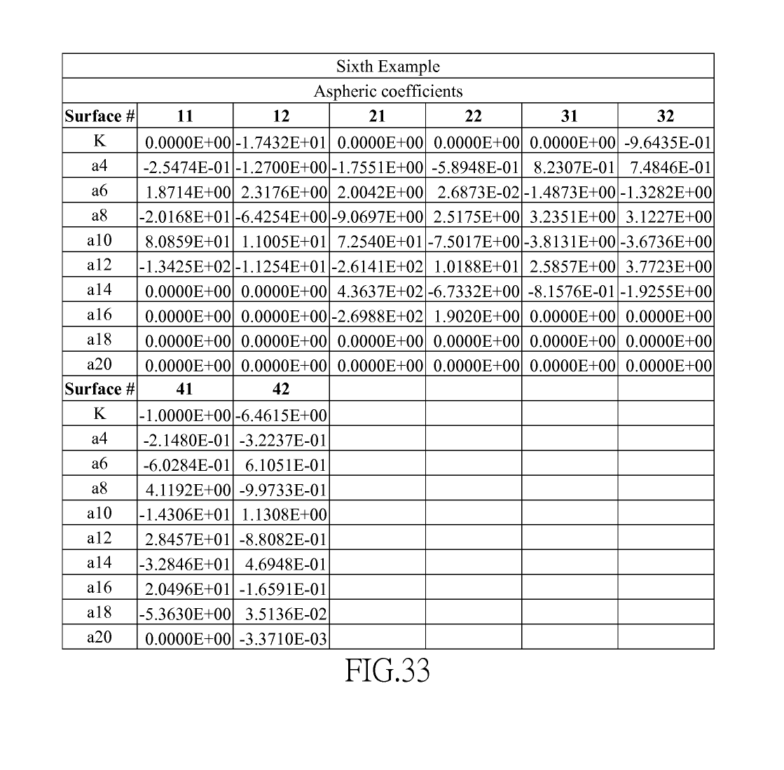

Please refer to FIG. 16 which illustrates the sixth example of the optical imaging lens set 1 of the present invention. Please refer to FIG. 17A for the longitudinal spherical aberration on the image plane 71 of the sixth example; please refer to FIG. 17B for the astigmatic aberration on the sagittal direction; please refer to FIG. 17C for the astigmatic aberration on the tangential direction, and please refer to FIG. 17D for the distortion aberration. The components in the sixth example are similar to those in the first example, but the optical data such as the curvature radius, the refractive power, the lens thickness, the lens focal length, the aspheric surface or the back focal length in this example are different from the optical data in the first example, and in this example, the first object-side surface 11 the first lens element 10 has a concave part 14C in a vicinity of its circular periphery. The optical data of the sixth example of the optical imaging lens set are shown in FIG. 32 while the aspheric surface data are shown in FIG. 33. The length of the optical imaging lens set is 3.344 mm. Image height is 1.557 mm, HFOV is 34.8568 degrees. Some important ratios of the sixth example are as follows:

T3/AAG=1.548

(G12+G34)/T2=0.612

|V1−V4|=0.000

(T1+T2)/AAG=2.996

T2/T4=0.579

ALT/AAG=6.459

EFL/T4=3.351

EFL+BFL=2.988

EFL/(G12+G23)=7.494

ALT/T2=5.823

EFL/T1=3.402

TTL/(G34+T4)=4.748

(T1+T3)/(G12+G23)=4.010

(AAG+ALT)/(G12+G34)=10.989

TTL/AAG=9.775

T1/T2=1.701

### SEVENTH EXAMPLE

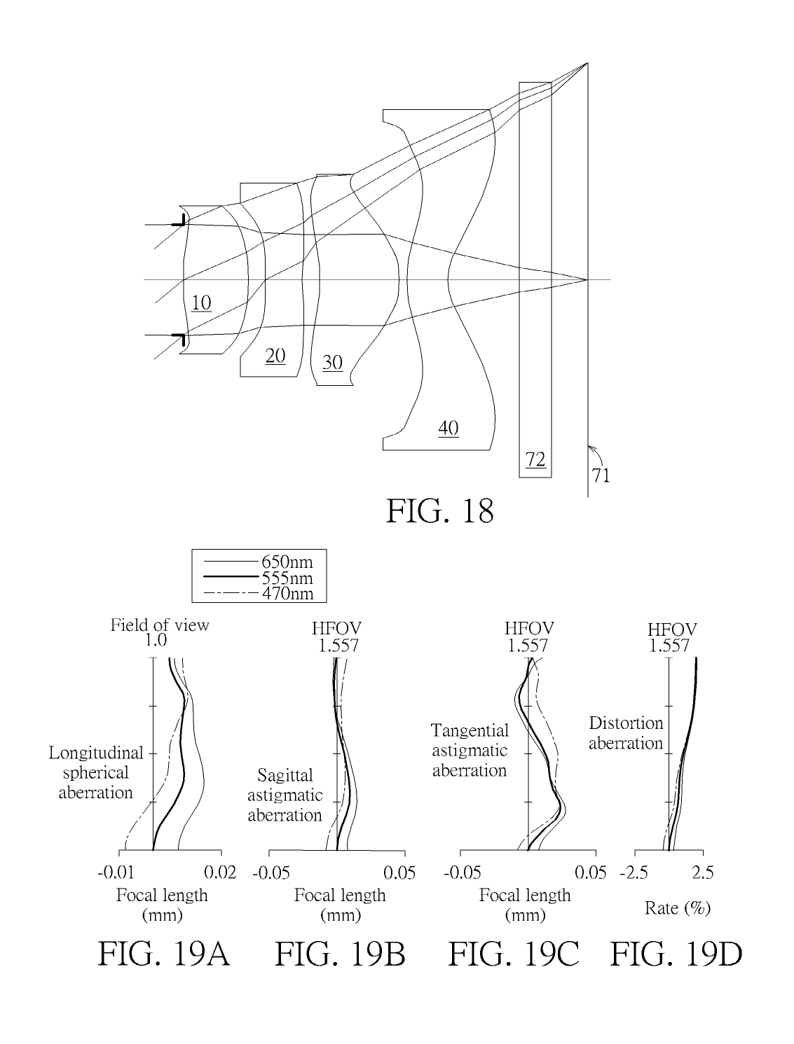

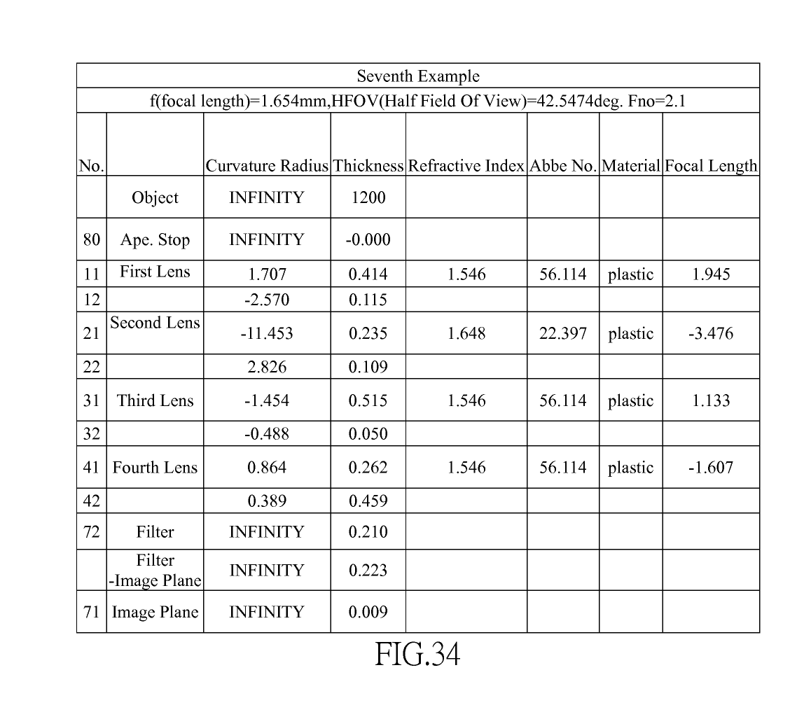

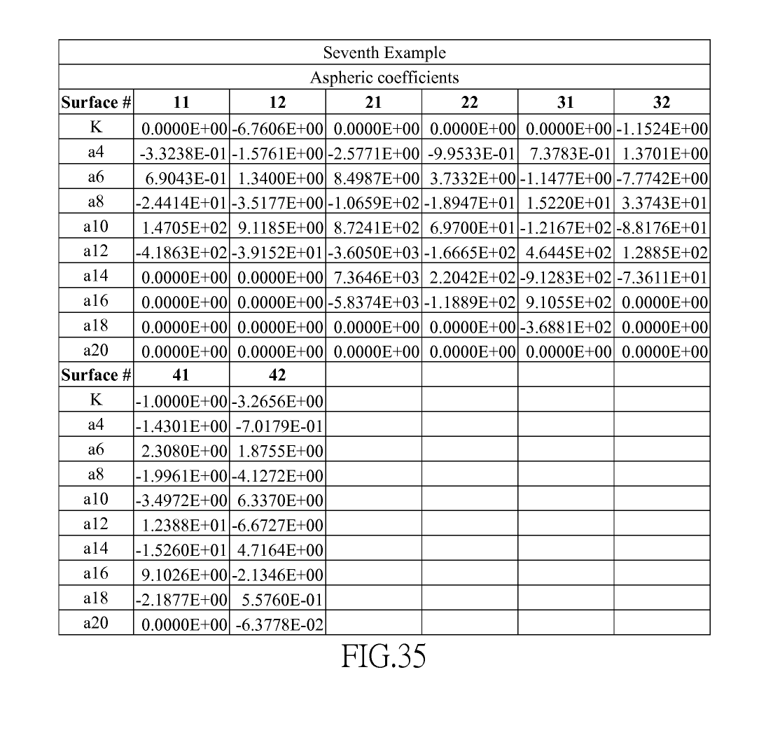

Please refer to FIG. 18 which illustrates the seventh example of the optical imaging lens set 1 of the present invention. Please refer to FIG. 19A for the longitudinal spherical aberration on the image plane 71 of the seventh example; please refer to FIG. 19B for the astigmatic aberration on the sagittal direction; please refer to FIG. 19C for the astigmatic aberration on the tangential direction, and please refer to FIG. 19D for the distortion aberration. The components in the seventh example are similar to those in the first example, but the optical data such as the curvature radius, the refractive power, the lens thickness, the lens focal length, the aspheric surface or the back focal length in this example are different from the optical data in the first example. The optical data of the seventh example of the optical imaging lens set are shown in FIG. 34 while the aspheric surface data are shown in FIG. 35. The length of the optical imaging lens set is 2.601 mm. Image height is 1.557 mm, HFOV is 42.5474 degrees. Some important ratios of the seventh example are as follows:

T3/AAG=1.877

(G12+G34)/T2=0.702

|V1−V4|=0.000

(T1+T2)/AAG=2.369

T2/T4=0.896

ALT/AAG=5.202

EFL/T4=6.307

EFL+BFL=2.555

EFL/(G12+G23)=7.377

ALT/T2=6.069

EFL/T1=3.990

TTL/(G34+T4)=8.330

(T1+T3)/(G12+G23)=4.144

(AAG+ALT)/(G12+G34)=10.311

TTL/AAG=9.485

T1/T2=1.764

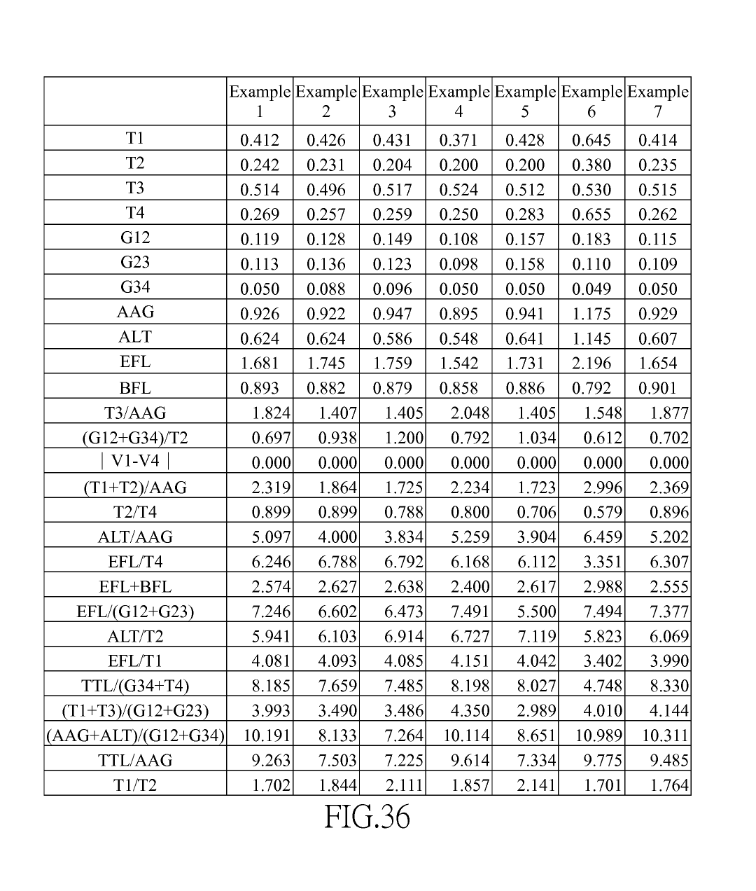

Some important ratios in each example are shown in FIG. 36.

In the light of the above examples, the inventors observe the following features:

1. The image-side surface of said first lens element has a convex part in a vicinity of its periphery, helping to collect the image light. In addition, the aperture stop is disposed between the object side and the first lens element, so as to enlarge the field of view.

(2) The object-side surface of said second lens element has a concave portion in a vicinity of the optical axis, the object-side of said third lens element has a concave portion in a vicinity of the optical axis, and a convex part in a vicinity of its periphery; the object-side surface of said fourth lens element has a convex portion in a vicinity of the optical axis, where each of the surfaces match each other, in order to improve the aberration and image quality.

In addition, the inventors discover that there are some better ratio ranges for different data according to the above various important ratios. Better ratio ranges help the designers to design the better optical performance and an effectively reduced length of a practically possible optical imaging lens set. For example:

(1) Since the third lens element has larger curvature radius, the thickness of the third lens element cannot be too thin, and it should be maintained within a suitable ratio to AAG. If the relationship of T3/AAG≧1.4 is satisfied, each lens element will has better arrangement, the preferable range is 1.4-2.1.

(2) When the optical imaging lens set is shrunk, the air gaps between two adjacent lenses and the thickness of the lens will be shrunk too. The image-side surface of the first lens element has a convex part in a vicinity of its periphery, the object-side surface of the second lens element has a concave portion in a vicinity of the optical axis, and the arrangement helps to further decrease G12. On the other hand, the object-side surface of the fourth lens element has a convex portion in a vicinity of the optical axis. Therefore the fourth lens element and the third lens element are closer, so G34 can be further shrunk. If the relationship of (G12+G34)/T2≦1.4 is satisfied, the optical imaging lens set has better arrangement.

(3) When the optical imaging lens set is shrunk, the issue of the chromatic aberration will become serious. If the relationship of |V1−V4|≦20 is satisfied, the optical imaging lens set has better achromatic ability.

(4) In order to shrink the optical imaging lens set, the air gaps between two adjacent lenses and the thickness of the lens element will be shrunk as much as possible, but considering the difficulties during the assembling process, usually the air gaps between two adjacent lenses can be shrunk less than the thickness of the lens element can. If the following relationships are satisfied, the optical imaging lens set has better arrangement: (T1+T2)/AAG≦3.5, the preferable range is 1.7-3.0; ALT/AAG≦6.5, the preferable range is 3.8-6.5; (T1+T3)/(G12+G23)≦5, the preferable range is 2.9-4.4.

(5) The second lens element has smaller optical effective apertures, and the object-side surface of the second lens element has a concave portion in a vicinity of the optical axis, so the thickness of the second lens element can be further decreased. If the following relationships are satisfied, the optical imaging lens set has better arrangement: ALT/T2≧5.8, the preferable range is 5.8-7.2; T2/T4≦0.9, the preferable range is 0.5-0.9; T1/T2≧1.7, the preferable range is 1.7-2.2.

(6) When the optical imaging lens set is shrunk, the effective focal length EFL of the optical imaging lens set and the thickness of the lens will be shrunk too. But the first lens element can be shrunk more than other lens elements can. If the following relationships are satisfied, the optical imaging lens set has better arrangement: EFL/T1≧3.4, the preferable range is 3.4-4.2.

(7) As mentioned above, when the optical imaging lens set is shrunk, not only will EFL, the focal length and the thickness of the lens be shrunk, but the air gaps between two adjacent lenses will also be shrunk too. However, since the fourth lens element has larger optical effective apertures, the thickness of the fourth lens element cannot be shrunk like others lens elements. Considering the difficulties during the assembling process, G12 and G23 cannot be shrunk unlimitedly. If the following relationships are satisfied, the optical imaging lens set has better arrangement and has shorter total length: EFL/T4≦6.8, the preferable range is 3.3-6.8; EFL/(G12+G23)≦7.5, the preferable range is 5.5-7.5.

(8) TTL is the distance between the first object-side surface of the first lens element to the image plane, when TTL is shrunk, the fourth lens element has larger optical effective apertures, and cannot be shrunk like others lens elements. On the other hand, considering the difficulties during the assembling process, G12 and G23 cannot be shrunk unlimitedly. If the following relationships are satisfied, the optical imaging lens set has better arrangement: TTL/(G34+T4)≦8.5, the preferable range is 4.7-8.2; TTL/AAG≦11.0, the preferable range is 7.2-9.8.

(9) In order to shrink the optical imaging lens set, the effective focal length EFL and the distance BFL between the fourth image-side surface of the four lens element to the image plane along the optical axis should be decreased as much as possible, but in the meantime, cannot influence the optical quality. If the following relationships are satisfied, the optical imaging lens set has better arrangement: EFL+BFL≦3.0, the preferable range is 2.4-3.0.

(10) In order to shrink the optical imaging lens set, AAG and ALT should be decreased as much as possible, but considering the difficulties during the assembling process, G12 and G34 cannot be shrunk unlimitedly. If the following relationships are satisfied, the optical imaging lens set has better arrangement: (AAG+ALT)/(G12+G34)≦11.0, the preferable range is 7.2-11.0.

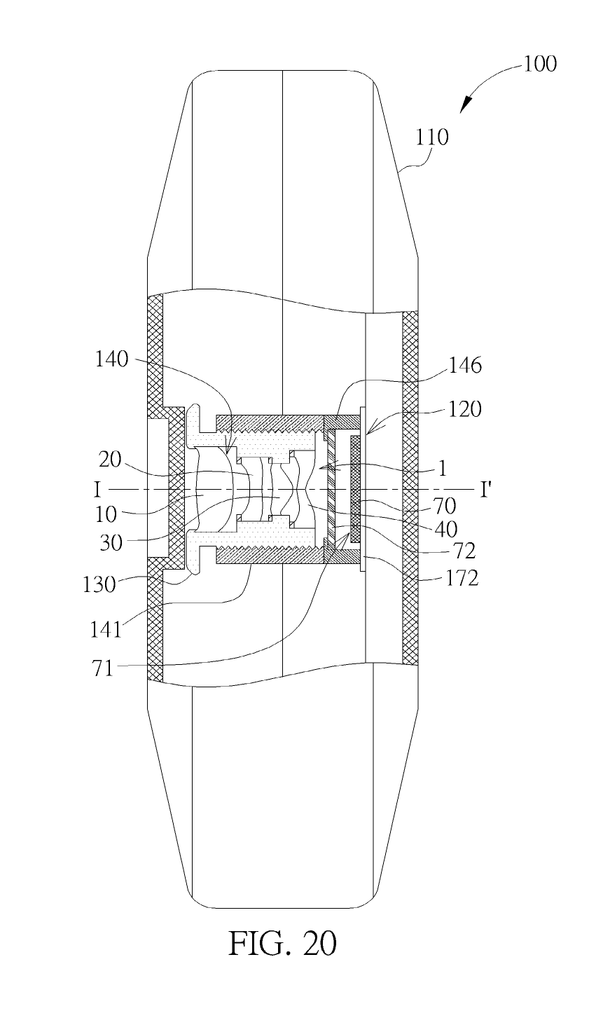

The optical imaging lens set 1 of the present invention may be applied to an electronic device, such as game consoles or driving recorders. Please refer to FIG. 20. FIG. 20 illustrates a first preferred example of the optical imaging lens set 1 of the present invention for use in a portable electronic device 100. The electronic device 100 includes a case 110, and an image module 120 mounted in the case 110. A driving recorder is illustrated in FIG. 20 as an example, but the electronic device 100 is not limited to a driving recorder.

As shown in FIG. 20, the image module 120 includes the optical imaging lens set 1 as described above. FIG. 20 illustrates the aforementioned first example of the optical imaging lens set 1. In addition, the portable electronic device 100 also contains a barrel 130 for the installation of the optical imaging lens set 1, a module housing unit 140 for the installation of the barrel 130, a substrate 172 for the installation of the module housing unit 140 and an image sensor 70 disposed at the substrate 172, and at the image side 3 of the optical imaging lens set 1. The image sensor 70 in the optical imaging lens set 1 maybe an electronic photosensitive element, such as a charge coupled device or a complementary metal oxide semiconductor element. The image plane 71 forms at the image sensor 70.

The image sensor 70 used here is a product of chip on board (COB) package rather than a product of the conventional chip scale package (CSP) so it is directly attached to the substrate 172, and protective glass is not needed in front of the image sensor 70 in the optical imaging lens set 1, but the present invention is not limited to this.

To be noticed in particular, the optional filter 72 may be omitted in other examples although the optional filter 72 is present in this example. The case 110, the barrel 130, and/or the module housing unit 140 may be a single element or consist of a plurality of elements, but the present invention is not limited to this.

Each one of the four lens elements 10, 20, 30 and 40 with refractive power is installed in the barrel 130 with air gaps disposed between two adjacent lens elements in an exemplary way. The module housing unit 140 has a lens element housing 141, and an image sensor housing 146 installed between the lens element housing 141 and the image sensor 70. However in other examples, the image sensor housing 146 is optional. The barrel 130 is installed coaxially along with the lens element housing 141 along the axis I-I′, and the barrel 130 is provided inside of the lens element housing 141.

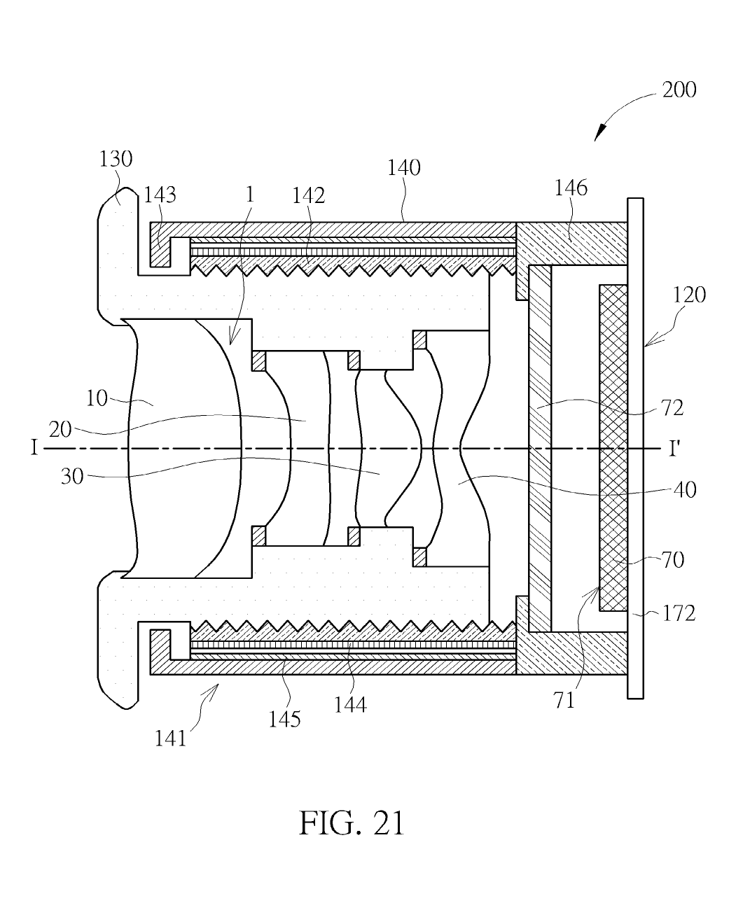

Please also refer to FIG. 21 for another application of the aforementioned optical imaging lens set 1 in a portable electronic device 200 in the second preferred example. The main differences between the portable electronic device 200 in the second preferred example and the portable electronic device 100 in the first preferred example are: the lens element housing 141 has a first seat element 142, a second seat element 143, a coil 144 and a magnetic component 145. The first seat element 142 is for the installation of the barrel 130, exteriorly attached to the barrel 130 and disposed along the axis I-I′. The second seat element 143 is disposed along the axis I-I′ and surrounds the exterior of the first seat element 142. The coil 144 is provided between the outside of the first seat element 142 and the inside of the second seat element 143. The magnetic component 145 is disposed between the outside of the coil 144 and the inside of the second seat element 143.

The first seat element 142 may pull the barrel 130 and the optical imaging lens set 1 which is disposed inside of the barrel 130 to move along the axis I-I′, namely the optical axis 4 in FIG. 6. The image sensor housing 146 is attached to the second seat element 143. The filter 72, such as an infrared filter, is installed at the image sensor housing 146. Other details of the portable electronic device 200 in the second preferred example are similar to those of the portable electronic device 100 in the first preferred example so they are not elaborated again.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens set, from an object side toward an image side in order along an optical axis comprising: an aperture stop, a first lens element, a second lens element, a third lens element and a fourth lens element, each lens element having refractive power, and having an object-side surface facing toward the object side as well as an image-side surface facing toward the image side, wherein:
said image-side surface of said first lens element has a convex part in a vicinity of its periphery;
said object-side surface of said second lens element has a concave portion in a vicinity of the optical axis;
said object-side of said third lens element has a concave portion in a vicinity of the optical axis, and a convex part in a vicinity of its periphery;
said object-side surface of said fourth lens element has a convex portion in a vicinity of the optical axis; and
the optical imaging lens set does not include any lens element with refractive power other than said first, second, third and fourth lens elements; a thickness T2 of said second lens element along said optical axis, a thickness T3 of said third lens element along said optical axis, an air gap AG12 between said first lens element and said second lens element along said optical axis, an air gap AG34 between said third lens element and said fourth lens element along said optical axis, the sum of all three air gaps AAG between each lens element from said first lens element to said fourth lens element along the optical axis, the Abbe number V1 of the first lens element, and the Abbe number V4 of the fourth lens element satisfy the relationships: T3/AAG≧1.4, (G12+G34)/T2≦1.4, and |V1−V4|≦20.

2. The optical imaging lens set of claim 1,wherein a thickness T1 of said first lens element along said optical axis satisfies a relationship (T1+T2)/AAG≦3.5.

3. The optical imaging lens set of claim 2, wherein a total thickness ALT of said first lens element, said second lens element, said third lens element and said fourth lens element along said optical axis satisfies a relationship ALT/T2≧5.8.

4. The optical imaging lens set of claim 1, wherein a thickness T4 of said fourth lens element along said optical axis satisfies a relationship T2/T4≦0.9.

5. The optical imaging lens set of claim 4,wherein the effective focal length EFL of the optical imaging lens set, and a thickness T1 of said first lens element along said optical axis satisfy a relationship EFL/T≧13.4.

6. The optical imaging lens set of claim 1, wherein a total thickness ALT of said first lens element, said second lens element, said third lens element and said fourth lens element along said optical axis satisfies a relationship ALT/AAG≦6.5.

7. The optical imaging lens set of claim 6, wherein the distance TTL between the first object-side surface of the first lens element to the image plane, and a thickness T4 of said fourth lens element along said optical axis satisfy a relationship TTL/(G34+T4)≦8.5.

8. The optical imaging lens set of claim 1, wherein the effective focal length EFL of the optical imaging lens set, and a thickness T4 of said fourth lens element along said optical axis satisfy a relationship EFL/T4≦6.8.

9. The optical imaging lens set of claim 8,wherein a thickness T1 of said first lens element along said optical axis, and an air gap AG23 between said second lens element and said third lens element along said optical axis satisfy a relationship (T1+T3)/(G12+G23)≦5.0.

10. The optical imaging lens set of claim 8, wherein a total thickness ALT of said first lens element, said second lens element, said third lens element and said fourth lens element along said optical axis satisfies a relationship (AAG+ALT)/(G12+G34)≦11.

11. The optical imaging lens set of claim 10,wherein the distance TTL between the first object-side surface of the first lens element to the image plane satisfies a relationship TTL/AAG≦11.

12. The optical imaging lens set of claim 1,wherein the effective focal length EFL of the optical imaging lens set, and a distance BFL between the image-side surface of said fourth lens element to an image plane satisfy a relationship EFL+BFL≦3.0.

13. The optical imaging lens set of claim 1,wherein the effective focal length EFL of the optical imaging lens set, and an air gap AG23 between said second lens element and said third lens element along said optical axis satisfy a relationship EFL/(G12+G23)≦7.5.

14. The optical imaging lens set of claim 13,wherein a thickness T1 of said first lens element along said optical axis satisfies a relationship T1/T2≧1.7.

15. An electronic device, comprising:
a case; and
an image module disposed in said case and comprising:
an optical imaging lens set of claim 1;
a barrel for the installation of said optical imaging lens set;
a module housing unit for the installation of said barrel;
a substrate for the installation of said module housing unit; and
an image sensor disposed on the substrate and disposed at an image side of said optical imaging lens set.
